(19) United States
(12) Patent Application Publication
(10) Pub. No.: US 2012/0110499 A1
(43) Pub. Date: May 3, 2012

(54) VIRTUALIZED LAYOUTS

(75) Inventors: Jeremy Eric Hance, Edmonds, WA (US); David Bruce Lindsay, Kirkland, WA (US); Jacob Edward Savin, Woodinville, WA (US)

(73) Assignee: Microsoft Corporation, Redmond, WA (US)

(21) Appl. No.: 12/915,702

(22) Filed: Oct. 29, 2010

(51) Int. Cl. G06F 3/048

(52) U.S. Cl. 715/781

(57) ABSTRACT

One or more techniques and/or systems are disclosed for virtualizing data in a user interface (UI). A virtual layout viewport is identified which comprises an area that may be viewed in a UI, where at least some data from one or more tuples of data is to be realized in the viewable area of the UI. Data that is to be realized in the viewport is identified from the one or more tuples of data, and the identified data is realized in the viewport, such as by creating a representation of the data for display in the UI. The realized data can be virtualized by removing the representation when the virtual layout viewport is modified in relation to a display of tuple data (e.g., an item is scrolled out of view).

### BACKGROUND

User interfaces (UIs) can be used in a computing environment to provide interaction with applications and/or data by users. For example, a computer application can provide a UI for users to view files stored locally on their computer, and/or remotely on a cloud-based network. Further, a UI can provide for the user to interact with the stored files, by opening them for viewing, editing, downloading or sending to another location. Further, a UI may comprise a plurality of UI controls that individually or collectively provide for interaction with disparate data locations, such as a social networking site providing feeds (e.g., news, contact updates, selected media) for various sites on the Internet. Virtualizing data is a technique where merely data items that are viewable are realized (e.g., displayed) in the UI control, while those that are not currently viewable are not realized, but represented in a way that simulates representation of the virtualized data items to the user, such as through interactive controls.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Previous attempts to create virtualized list controls have made simplifying assumptions about the nature of list controls, such as the size and layout of items. Although these current or previous techniques may create lists that are virtualized, which can reduce memory use, they typically impose a number of limitations on the user interface (UI) that may comprise the list. For example, using current techniques, all items need to be the same size for the list to function properly; items cannot themselves contain more virtualized lists (e.g., nested virtualized lists); and a specific implementation of a virtualized list needs to have specific layout and behavior (e.g. separate any vertical lists from horizontal lists), which cannot easily be customized.

Accordingly, one or more techniques and/or systems are disclosed where core logic for a virtualized list (e.g., a Virtual Layout) is abstracted (e.g., separated) from functionality that utilizes specific knowledge of a desired layout mode. Using the one or more techniques, for example, arbitrary layout modes (e.g., vertical list, horizontal list, vertical grid, horizontal grid, etc.) can be combined or used together in a UI display without rewriting virtualization or databinding logic. Further, variably sized items can be integrated into a UI control, for example, while retaining virtualization; and, because items can be variably sized, the realized items can also comprise embedded virtualized lists (e.g., nested UI controls) that are n-levels deep, of varying layout modes (e.g. a vertical grid embedded in a vertical list embedded in a vertical list), for example.

In one embodiment for virtualizing data in a user interface (UI), a virtual layout viewport is identified, which comprises a viewable UI area, such as in a UI control, where at least some data from one or more tuples of data is realized (e.g., as UI elements). Further, data that is to be realized in the viewport is identified from the one or more tuples of data, and the identified data is realized in the viewport, such as in the UI control. Additionally, realized data (e.g., as UI elements) is virtualized (e.g., deconstructed) when the virtual layout viewport is modified in relation to a display of tuple data, such as by the user moving the viewport using an associated interface control.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram illustrating a rendering afforded by conventional technology where one or more items may be displayed while one or more other items may be virtualized.

FIG. 2 is a flow diagram illustrating an example method for virtualizing data in a UI.

FIG. 3 is a flow diagram illustrating virtualizing data in a UI in accordance with at least some of one or more of the techniques and/or systems provided herein.

FIG. 4 is an illustration of an example UI display that may be provided in accordance with at least some of at least one of one or more of the techniques and/or systems provided herein.

FIG. 5 is a block diagram illustrating an example system for virtualizing data in a UI.

FIG. 6 is a block diagram illustrating virtualizing data in a UI in accordance with at least some of one or more of the techniques and/or systems provided herein.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

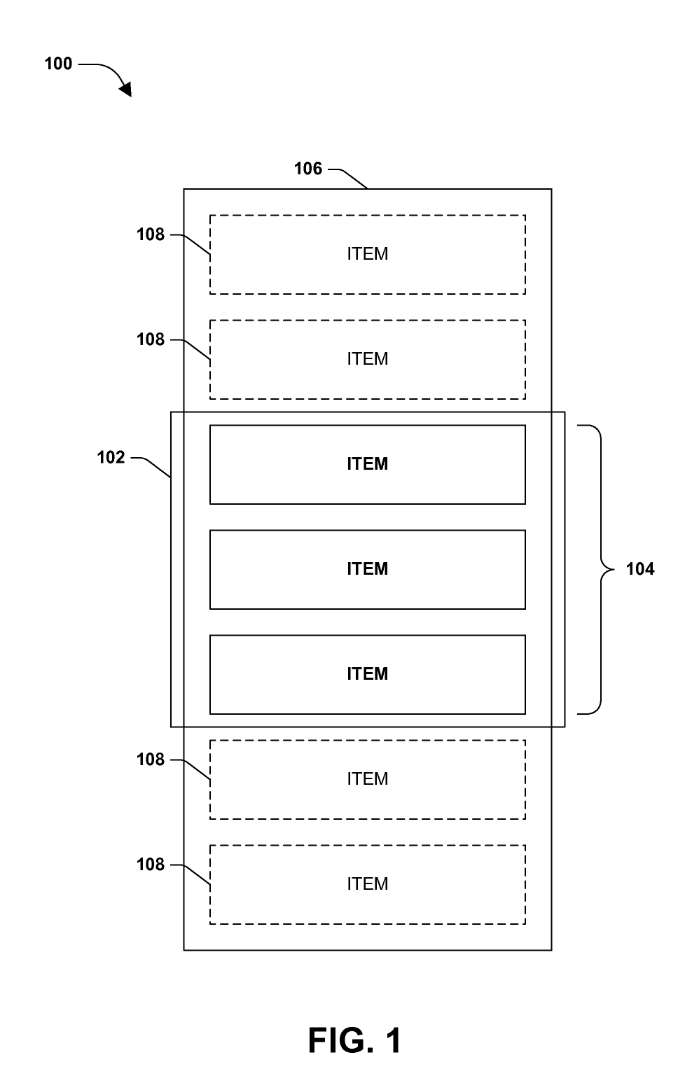

FIG. 1 illustrates an example embodiment 100 of existing technology, where one or more items may be displayed, while one or more items may be virtualized. In this example embodiment 100, a display list of items 106, such as multi-media (e.g., songs) information (e.g., title, artist, album, etc.) displayed on a media player, can comprise realized items 104 and virtualized items 108. Further, the realized items 104 are realized (e.g., created for viewing) and displayed in a viewport 102, which can comprise a viewable area of an application and/or display screen of a device. Additionally, those items 108 outside the viewport 102 are virtualized (e.g., not created), for example, such that the list may still maintain characteristics of a list that includes all of the items 104 and 108.

For example, a list of items, such as text, images, or a combination of text and images, may span more than can fit inside the viewing area for an application displaying the items. As an illustrative example, a user's inbox may comprise a plurality of emails, where only ten email headers may fit on a display screen or in the viewing window of the email program at a time. In this example, the viewing window can be moved over the list of email headers, or the list of email headers can be moved across or up and down in the viewing window. As the email headers come into the viewing window they are realized, such that they can be viewed.

That is, for example, user interface (UI) elements that represent the items that enter the viewing area are created when the item is realized in the viewing window. Further, as items move out of the viewing window they are virtualized. That is, for example, the UI elements representing the items that move out of the viewing area are destroyed, unwound, etc. when the item leaves the viewing window. In this way, for example, merely those items in the viewing window need to be created for viewing at any particular time, while the remaining list items are virtually represented (not viewable) for the list. The virtualization of the items outside the viewing window can provide for interaction with the list that feels like the entire list is realized, such as by having a slider bar at a side of the viewable list that can be used to navigate through the list, where the slider bar is representative of the entire list as if it were viewable. However, the items in the list in FIG. 1 are all the same size, have the same properties, etc.

A method may be devised that provides for virtualizing data in a user interface (UI), for example, where items representing the data may be of different sizes, shapes, configurations, and/or layouts. Further, the items representing the data may be comprised in nested virtual controls, such that a virtual layout may be inside another virtual layout, which may also be inside another virtual layout, and so-on. In this way, for example, UI controls that comprise virtualized layout may not be limited to a simple list, as in FIG. 1, but can utilized combined layouts, which may comprise horizontal and vertical lists, text and images in different layouts and/or of different layout sizes, and/or nested versions of any type of layout.

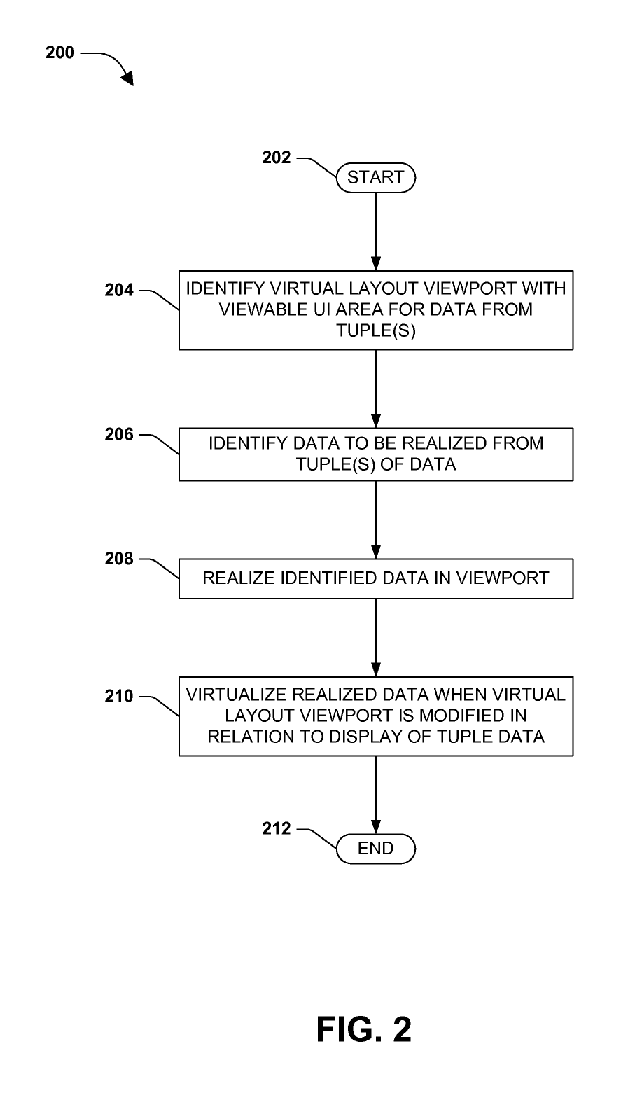

FIG. 2 is a flow diagram of an exemplary method 200 for virtualizing data in a UI. The exemplary method 200 begins at 202 and involves identifying a virtual layout viewport that comprise a viewable UI area where at least some data from one or more tuples of data is realized, at 204. For example, an application may comprise a viewable area where realized UI data elements may be displayed. In one embodiment, the viewable area of the application can comprise the virtual layout viewport, and a configuration (e.g., height, width, zoom level, resolution, etc.) may be identified for the viewable area, such that a layout of realized data items may be appropriately displayed, sized, etc. to the viewable area, for example.

At 206, data from the one or more tuples of data that is to be realized in the viewport is identified. That is, in one embodiment, the data items that may fit in the viewport, in a desired layout mode, can be identified separately (e.g., abstracted) from the identification of the viewing area, for example, and the layout mode of the items in the viewing area. For example, the one or more tuples (e.g., virtualized ordered lists of data items, such as emails, pictures, social network feeds, songs, contacts, etc.) can be maintained separately from a viewing area layout of realized items.

In this way, as an illustrative example, arbitrary layout modes (e.g., vertical lists, horizontal lists, vertical grids, horizontal grids, etc.) may be utilized and/or combined without having to rewrite virtualization and/or data-binding logic for the application. Further, in this example, variably sized items may be laid-out in the viewing area while virtualization is maintained. Additionally, in this example, because variably sized items may be used, embedded virtualized controls (e.g., comprising virtualized lists) may be comprised within (e.g., nested or embedded in) another virtualized list, such as to n-deep levels comprising various layout modes.

At 208 in the exemplary method 200, the identified data is realized in the viewport. In one embodiment, realizing the data can comprise creating a UI item for the data, such that the UI data item is viewable as a representation of the data in the viewport, for example, on a display of a device running the application. For example, one or more of the data may comprise an image, such as in a photo album from an online social networking site. In this example, the realized data can comprise the image displayed in the viewport, along with photo tag information, and/or other information associated with the image (e.g., comments from connections on the social network).

At 210, the realized data is virtualized when the virtual layout viewport is modified in relation to a display of tuple data. That is, for example, the realized data can be virtualized when the realized data is moved out of the viewport, such as a user moving the viewport (e.g., panning), and/or the user moving the list (e.g., using a slider bar). In one embodiment, the virtualization of the realized data can comprise removing or deconstructing the UI data item, such that it may no longer be viewed in the viewport of the application. For example, the UI element representing the data item can be destroyed, and merely the data associated with the element can be retained, such as in memory, thereby freeing up resource on the client computer. Further, in this example, the layout mode, comprising one or more lists of data laid-out in one or more desired layouts, can retain a functionality of the entire layout of data (e.g., an entire list of data even though merely a portion is realized).

Having virtualized the realized data when the virtual layout viewport is modified, the exemplary method 200 ends at 212.

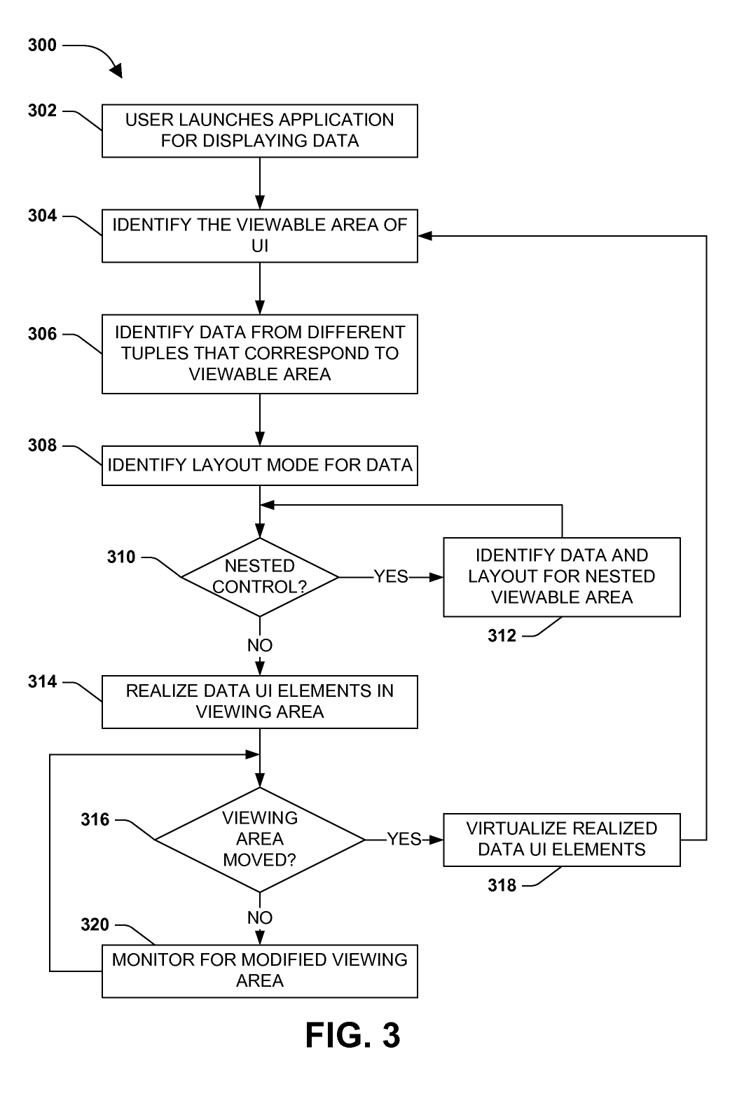

FIG. 3 is a flow diagram illustrating one embodiment 300 of an implementation of one or more techniques described herein. At 302, a user launches an application that can display data items. For example, an application may comprise an email program displaying emails, a browser that displays various lists of data (e.g., files locally, or webpages remotely), a web-page that displays various data items, etc. In one embodiment, the application can comprise a user interface (UI) control, for example, that allows the user to interact with the application and the data displayed in the UI control.

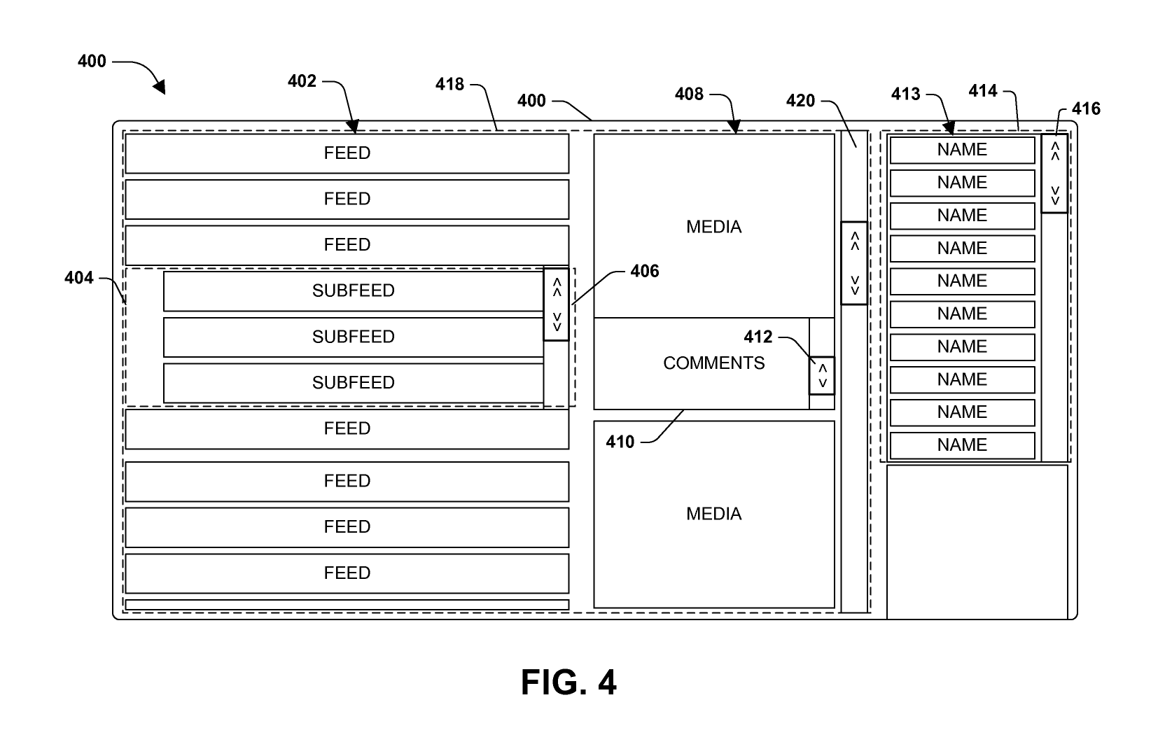

FIG. 4 illustrates an example embodiment 400 of an implementation of one or more techniques described herein. The example embodiment 400 comprises a UI display 400, where one or more UI controls may be rendered, for example, for viewing and interaction by a user. Further, a UI control can comprise at least a portion of the UI that provides for the user to control one or more aspects of the application. For example, in the example embodiment 400, the UI 400 may comprise a page that displays combined information from a variety of online and offline sources, such as social networks, cloud-based files, online news feeds, locally stored and/or remotely stored media, and/or local and online contacts. Additionally, as an example, a UI control that allows the user to view their contacts 413 can comprise a slider bar 416 that allows the user to interact with the UI control, such as by moving the slider up or down the bar.

Returning to FIG. 3, at 304, where identifying a virtual layout viewport can comprise identifying the viewable UI area based on a user interaction with the UI. That is, for example, a size, configuration, and/or location of the viewable area of the UI controls may depend on whether or not the user has interacted with the control, such as by moving the viewable area over a tuple of data items, by moving the tuple of data items across (e.g., using a slider bar) or around (e.g., panning) in the viewable area of the UI control, and/or expanding, contracting, or otherwise reconfiguring a size of the viewable area.

For example, as illustrated in the example embodiment 400, a UI control 404 comprises sub-feed data elements of a feed item in a feed UI control 402. Further, the viewable area of the sub-feed UI control 404 comprises a particular size and shape, and also comprises a particular location in a tuple that comprises the sub-feed data items (e.g., at a beginning of the list of sub-feed data, as indicated by the slider positioned at a beginning/top of the slider bar of the control 406). In this example, the virtual layout viewport can comprise the viewable area of the sub-feed UI control 404.

Returning again to FIG. 3, at 306, where identifying data can comprise identifying data from the one or more different tuples that is viewable in the UI area in relation to the one or more tuples. In one embodiment, as described above, the identification of the data that may be realized in the viewport is abstracted (e.g., a separate process) from the identification of the viewable area. That is, for example, the viewable area can be determined, and then the data that may fit inside the viewable area can be identified. In this way, in this example, a variety of data item layouts may be provided for data items from the one or more tuples that are realized.

For example, in FIG. 4, the UI control 418 comprises feed items 402 (e.g., text-based) and media items 408 (e.g., image-based); and the feed items further comprise sub-feed items 404. In this example, the respective data items may be comprised in different tuples, and may also be stored or collected from different locations (e.g., different local and/or remote locations).

As an illustrative example, the feed data items 402 may come from one or more social network sites subscribed to by the user, one or more user email accounts, one or more news sites, and/or a plurality of other locations where text-based data items can be displayed. Further, the media-based items 408 may also come from variety of sources, for example, much like the feed items, and may also come from local storage (e.g., user photos, songs, videos, etc.). Respective tuples can provide data elements for the viewable area of the UI control 418, for example, in relation to a configuration of the viewport, and/or a location of the viewport in relation to the tuple (e.g., which part of the tuple is covered by the viewport based on the user's interaction with the UI control 404).

Returning to FIG. 3, at 308, a layout mode is identified for the data identified from the one or more tuples, where, in one embodiment, one or more layouts can be identified for data that may be realized in the viewport. In one embodiment, the layout of realized data items in the viewport can be determined separately from the viewing area of the viewport, and the data items that may correspond to the viewport. For example, a developer of a UI control may design a desired layout that combines or alters more traditional layouts (e.g., horizontal or vertical lists and grids).

As an example, in FIG. 4, the main body of the UI 400 comprises the UI control 418 that displays a feed list 402 and a media list 408, where the lists are combined in a layout that can be vertically scrolled using the slider bar 420 for the control. In this example, the developer can design the layout mode to comprise a text-based feed on the left, and a media-based feed on the right, where the UI control display can be scrolled, thereby scrolling both the text feed 402 and the media feed 408.

It will be appreciated that the layout mode is not limited to these examples, and it is anticipated that those skilled in the art may devise alternate embodiments for a layout mode of data items in UI control that provides for virtualization. For example, the layout may comprise data items from different tuples that are linked in a viewport, where scrolling through, or panning over the linked tuples changes the data items displayed, but the different tuples remain linked in the display. As another example, a layout can comprise a combination of vertical and horizontal layouts of lists, along with a grid layout of data items, where respective data items can be linked in the viewport or where respective lists comprise individually controlled viewports.

Returning to FIG. 3, at 310, it can be determined whether the layout mode comprises one or more nested controls. In one embodiment, at least one second virtual layout viewport can be nested in the virtual layout viewport. Further, in one embodiment, at least one third virtual layout viewport can be nested in the second virtual layout viewport. For example, the viewable area comprised in the virtual layout viewport identified at 304 can comprise another virtual layout viewport, such as a second UI control nested in a first UI control. Additionally, a third virtual layout viewport can be nested in the second virtual layout viewport, and a fourth and so on, to n-nested viewports (e.g., n-nested UI controls).

As an illustrative example, in FIG. 4, the UI control 418 comprises two nested UI controls 404, 410. In this example, respective feed data items 402 may comprise realized second UI controls, such as the sub-feed UI control 404 when a feed item comprises sub-feed items. Further, in this example, the media data items 408 in the layout of the UI control 418 comprise a comment data item that is realized as a nested UI control 410. In this example, the comment UI control 410 nested in the main UI control 418 can also comprise a means to move the comments or the viewable area of the nested UI control 410, such as by using a slider bar 412.

At 312 in the example embodiment 300, if there is a nested virtual layout viewport, such as a nested UI control, in the identified layout mode, data and a layout mode for the nested virtual layout viewport can be identified. As described above at 306 and 308 respectively, the data associated with the viewable area of the nested UI control, for example, can be identified, and the layout of the data item from one or more tuples can also be identified for the nested UI control. In one embodiment, it can be determined whether the layout mode for the nested UI control comprises another nested UI control, at 310 (and so-on).

If a nested UI control is not identified at 310, the identified data items can be realized as UI elements in the viewing area of the control(s). In one embodiment, realizing data can comprise creating a UI representation of the identified data for display in the viewport. For example, a data item in a tuple may be stored in local memory, storage, or remotely in a cloud computing network; and the data item is realized in the UI display merely when the viewport is appropriately associated with the data item in the tuple (e.g., it is determined that the location of the viewport matches the location of the data item in the tuple of data items), in accordance with the desired layout for the data item. Further, the viewport can comprise one or more nested viewports, as described above, and realizing the data time may comprise realizing a nested viewport, which may further comprise realizing another data item in the nested viewport.

For example, as illustrated in FIG. 4, when the layout mode is determined for the identified data (e.g., from one or more tuples), for the identified viewport (e.g., identified location and configuration), respective data items can be realized as UI elements, such as the feed elements 402, the media elements 408 and the name/contact elements 413. That is, in this example, while the tuple for the feed elements 402 may comprise hundreds of data items, merely those seven that have been identified for the viewport 418 and the layout are created and displayed. Further, remaining elements remain “virtualized,” for example, where the data items remain stored (e.g., in memory, storage, or remotely), but they are virtually represented by control portions (e.g., slider bars 420, 416) associated with respective UI controls 418, 414.

Additionally, in the example embodiment, where the layout modes comprise nested controls 404, 410 the nested UI controls are created and realized in the main UI control 418. In this example, the nested sub-feed control 404 comprises data elements from a sub-feed tuple that have been realized as sub-feed UI elements. Here, while the sub-feed tuple of data elements may comprise a plurality of data items, merely those that have been identified for the viewport 404, and the associated layout, are realized in the nested UI control 404. Further, while merely the three sub-feed UI elements are realized, the remaining data items in the sub-feed tuple are virtualized, and represented in the UI control 404 by the interactive control 406. That is, for example, the slide portion or the slider bar indicates that additional elements are present for the sub-feed UI control, by merely comprising about half of the slider bar 406 in size.

In one embodiment, respective portions of the realized data can be realized in the respective one or more layouts in the virtual layout viewport. For example, as illustrated in FIG. 4, the UI 400 comprises two virtual layout viewports 418 and 414; and the UI control 418 comprises a feed layout 402 and media layout 408 that have been combined, with each comprising a nested UI control 404, 410. In this embodiment, the data items that are realized in the respective layouts may be from different tuples, but the data items may be realized in a combined layout mode, such as the feed tuple and media tuple realized together in the main UI control 418. In this way, for example, data items from different tuple may be realized in combination with other data items from other tuples, and multiple layouts may be realized within a same UI control, and/or multiple UI controls, as shown in the UI 400.

Returning to FIG. 3, the viewing area, comprising the virtual layout viewport, may be moved, such as by a user interacting with an interactive control of the UI control (e.g., slider, panning operation, scrolling a mouse wheel, etc.). If the viewing area, comprising the area in the UI that is displaying the realized data items to the user, is moved, at 316, the realized data items (e.g., the created UI elements displayed in the UI) that are moved out of the viewing area are virtualized, at 318. In one embodiment, virtualizing the data can comprise eliminating a UI representation of at least some of the realized data from display in the viewport.

As an example, data items represented as UI elements can be virtualized when they are moved out of the viewport or the viewport is moved away from the UI elements. In one embodiment, while the UI element representations are eliminated (e.g., deconstructed from viewing in the display and memory), the data that the UI elements represented can be maintained locally or remotely, such as stored in the tuple (e.g., in local memory, storage or remote storage). In this way, the resource intensive nature of providing a UI element representation of the data items can be mitigated, while the data is maintained in a less resource intensive manner.

In FIG. 4, for example, if the user interacts the slider bar 420 for the main UI control 418, such as by selecting the slider and moving it downward, the viewing area of the UI control 418 will be associated with a different portion of the at least two tuples (e.g., a first for the feed 402 and a second for the media 408). That is, for example, by modifying the viewing area using the slider bar 420, the user has moved the viewport to another position. In this embodiment, when the viewport is moved to another location, the new location can be identified (e.g., and/or a new configuration for the viewport can be identified if the size or shape are modified), and the data associated with the new location for the one or more tuples can also be identified.

Returning to FIG. 3, after UI elements that are moved out of the viewing area are virtualized, at 318, the new viewable area of the UI control can be identified, such as by identifying the new location of the viewport in relation to the one or more tuples associated with the UI control, at 304. Further, the data from the one or more tuples that correspond to the newly identified viewable area can be identified, at 306; and the layout mode for the identified data in the new viewable area can be determined, at 308, as described above.

Alternately, if the viewable area is not moved, at 316, the viewing area can continue to be monitored, at 320, for example, for user interactions that may change a location and/or configuration of the viewing area.

In one aspect, a user may wish to select one or more of the data items represented as UI elements in one or more of the viewports (e.g., viewing areas of the UI controls). In one embodiment, selecting realized data items from one or more viewports can comprise selecting the data items from nested virtual layout viewports. In this embodiment, the selecting of realized data items can be provided by using an n-tuple index. For example, an n-tuple index can comprise an ordered series of numbers that index the data items in the UI controls down through a plurality of levels of nested controls.

In one embodiment, the n-tuple index can comprise an ordered number set for respective levels of nesting, where subsequent (or lower level) nested UI controls add a number for their corresponding ordered set to the higher level number. As an illustrative example, selecting 1.1.4 can comprise selecting the UI element that is the fourth item in a second nested UI control, which is nested in the first item of a first nested control, which is further nested in the first item of the top level control. As another example, as illustrated in FIG. 4, if the user selected the second sub-feed item, the n-tuple index for this selection may comprise 1.3.2, as the second item in control that is nested in the third item of the topmost layout 402, which is the first layout in the topmost control 418.

In one embodiment, the selection of realized data in the one or more virtual layout viewports can comprise selecting a range of elements in an n-tuple index, such as for those that comprise nested virtual layout viewports. For example, a range of 1.2.3 to 2.1 may be selected by the user, where the items from the third item in the second item nested in the first item at the topmost level to the first item nested in the second item at the topmost level are selected. As another example, the selection can be maintained as a collection of ranges of such indexes, such as: [1.2.3, 2.1), (2.1, 4.2]. In this example, the items from 1.2.3 inclusive to 2.1 exclusive, and the items from 2.1 exclusive to 4.2 inclusive are selected.

A system may be devised for that provides for virtualizing data in a user interface (UI), allowing data to be represented in different layouts. Further, the UI elements may comprise nested UI controls, such that a virtual layout may be inside another virtual layout. The system can separate the virtual viewport portion of the layout from the layout mode comprising the data, for example, thereby providing for layout of data items in a UI where portions of the data are virtualized and other portions are realized in the UI, and the layout can be arbitrary.

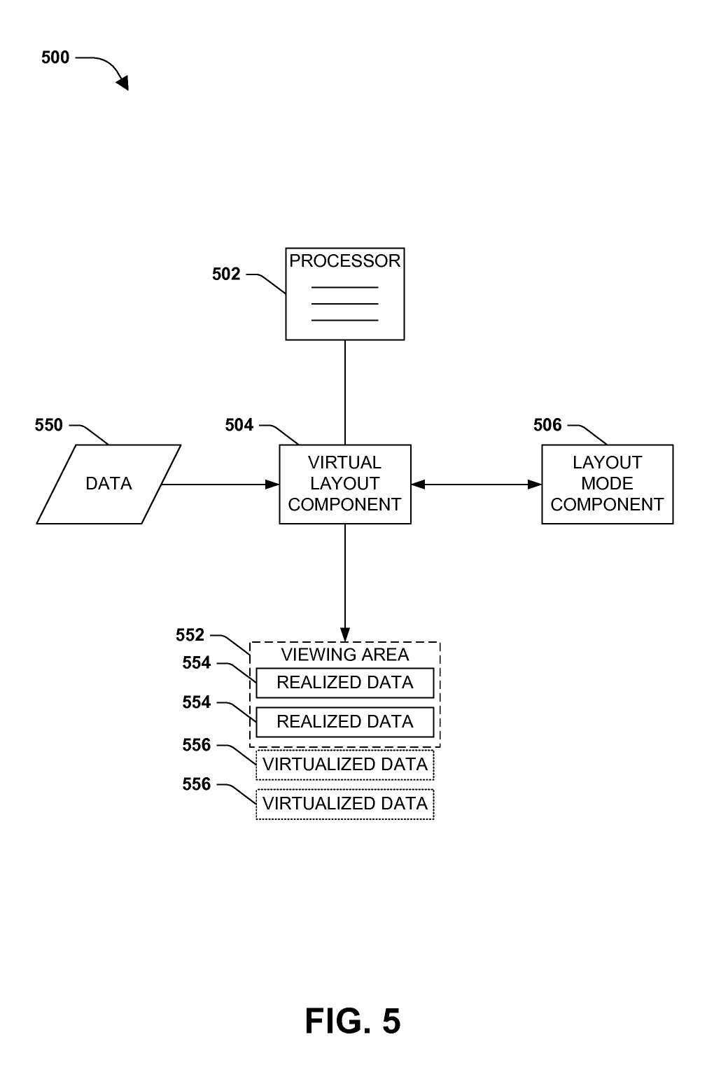

FIG. 5 is a component diagram of an exemplary system 500 for virtualizing data in a UI. A processor 502 processes data for the system, and a virtual layout component 504 is operably coupled with the processor 502. The virtual layout component 504 identifies a virtual viewing area 552 of the UI in which realized data 554 from one or more tuples of data 550 relationally coupled with the UI is displayed. For example, a user may activate (open) an application comprising the UI and select one or more tuples, such as locally and/or remotely stored files, remote feeds, ranges in a database, etc., (e.g., or the tuples are automatically selected by the application when opened). In this example, the selected tuples are relationally associated (coupled) with the UI, for example, such that the data can be represented as UI elements (displayed) in the UI, where appropriate.

Further, the virtual layout component 504 realizes and virtualizes data from the one or more tuples in the virtual viewing area. For example, the data from one or more tuples can be realized 554 in the viewing area 552 if it is identified as data associated with the location of the virtual viewing area in relation to the tuple(s). That is, in this example, the virtual viewing area can comprise a location in the UI associated with the tuples, where merely the data from the one or more tuples associated with the identified location can be realized. In one embodiment, in order to realize the data, UI elements are created by the virtual layout component 504, such that the UI elements represent the corresponding data from the one or more tuples.

Further, the realized data in the virtual viewing area can be virtualized 556, for example, if it is identified as data that is outside the location of the virtual viewing area in relation to the tuple(s). As an illustrative example, when the UI is first activated, some data may be realized 554 if it corresponds to the location of the viewing area of the UI, while other data is virtualized 556, if it is outside the viewing area. In this example, if the viewing area is modified, such as moving the data or viewing area over the one or more tuples or layout of data (e.g., panning, slider bar, scrolling, etc.), the data that was realized may be virtualized if it no longer corresponds to the location of the virtual viewing area for the UI. Additionally, in this example, data that is moved into the viewing area may now be realized.

The exemplary system 500 further comprises a layout mode component 506 that is operably coupled with the virtual layout component 504. The layout mode component 506 identifies a layout of realized data based on the identified virtual viewing area 552. In one embodiment, the layout of the identified data, for the identified virtual viewing area, may be arbitrary for respective user interfaces, and/or UI controls inside the user interfaces. For example, a designer of the UI can develop a desired layout of the realized data 554 in the virtual viewing area 552, such as combining various types of layouts (e.g., grids, lists, horizontal layouts), and/or nesting one or more UI controls inside other UI controls as realized data elements.

In this way, for example, the identification of the virtual viewing area (e.g., where data items are realized, yet the UI control maintains a representation of virtualized elements, such as in an interactive (scroll bar type of) control), such as a location in the UI, and/or configuration (e.g., size and shape), can be performed separately from the identification of the data to be realized, and the layout of the data to be realized.

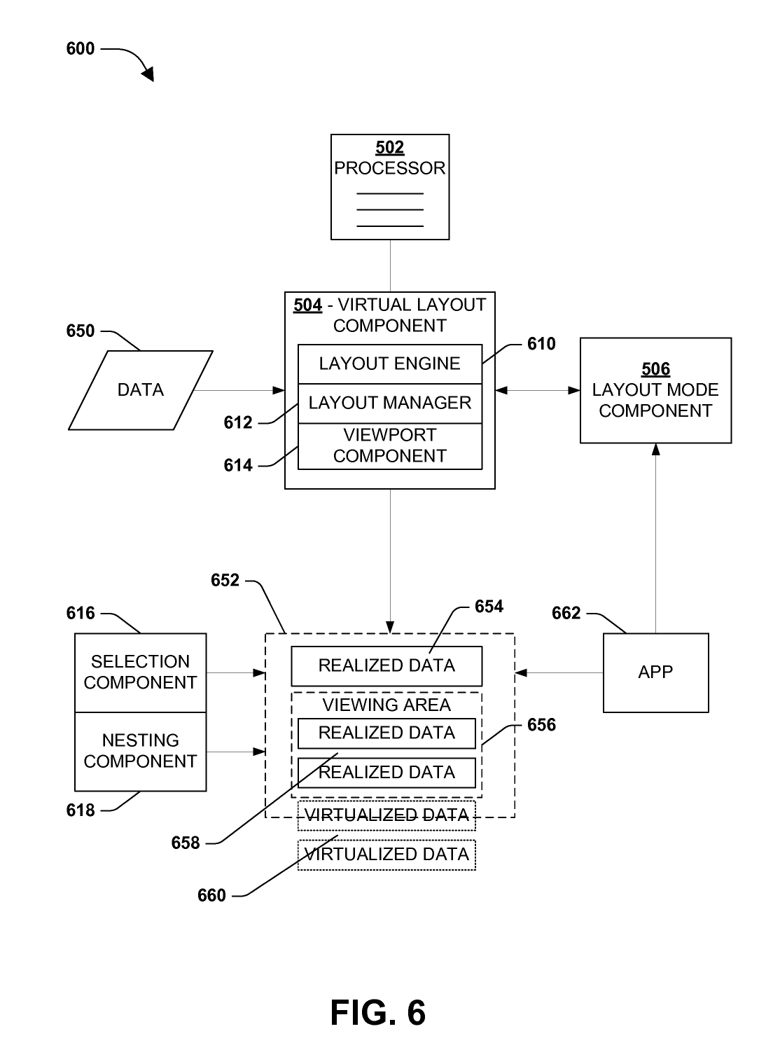

FIG. 6 is a component diagram of an example embodiment 600 where one or more systems described herein are implemented. In this embodiment 600, the virtual layout component 504 comprises a layout engine 610 that identifies the data 650 from the one or more tuples to be realized using the virtual viewing area 656 and the layout of the realized data 658. That is, for example, based on the location of the viewing area 656 in relation to the data 650, and how the realized data items are to be layout out, the layout engine 610 can determine which of the data from the one or more tuples will be realized.

Further, virtual layout component 504 comprises a layout manager 612 that can realize and virtualize the data, and maintain a list of data identified by the layout engine. For example, the layout manager 612 can create a UI element representation for the data that has been identified as realized data 658 by the layout engine 610, for display in the viewing area 656 of the UI. Further, as an example, the layout manager 612 can remove (e.g., deconstruct) those UI elements representations of data that are virtualized 660, as identified by the layout engine 610.

The virtual layout component 504 can also comprise a viewport component 614 that can maintain the virtual viewing area 656 that is exposed to a user of the UI, such as by maintaining a location relationship with the tuples for the viewing are. Further, the viewport component 614 can display the realized data 658 in the virtual viewing area 656, and may provide for the user to modify a location of the virtual viewing area in relation to tuple data, such as by providing a user interaction control.

In the example embodiment 600, a nesting component 618 can provide for nesting a second UI control comprising a second virtual viewing area 656 in a first UI control comprising a first virtual viewing area 652. For example, the first virtual viewing area 652 can comprise realized data elements 654, one of which can comprise a nested UI control that comprises the second virtual viewing area 656. In this way, in this example, the second viewing area 656 can also comprise realized data 658 and virtualized data 660, which is nested inside the first UI control.

A selection component 616 can provide for selection of realized data 658, 654 in one or more nested UI controls using an n-tuple index to identify the realized data selected. That is, for example, the selection component 616 allows a user to effectively select realized data elements that may span between one or more nested virtual viewing areas, such as in nested controls. The selection component 616 can use the n-tuple index, such as utilizing numbers indexed to the various realized elements at the different levels of the nesting, to effectively provide for selection of these elements, for example.

In the example embodiment 600, the layout mode component 506 is coupled with an application 662 that utilizes the UI to display the realized data 658. The layout mode component 506 can utilize the application to facilitate identifying the layout of the realized data in a desired manner for display in the virtual viewing area. For example, the application may comprise particular layout modes for the one or more UI controls displayed in the UI, such as created by the developer of the application. In this example, the application can provide appropriate layout modes to the layout mode component, which can be provided to the virtual layout component 504 in order to identify the appropriate data for the realization, and/or virtualization.

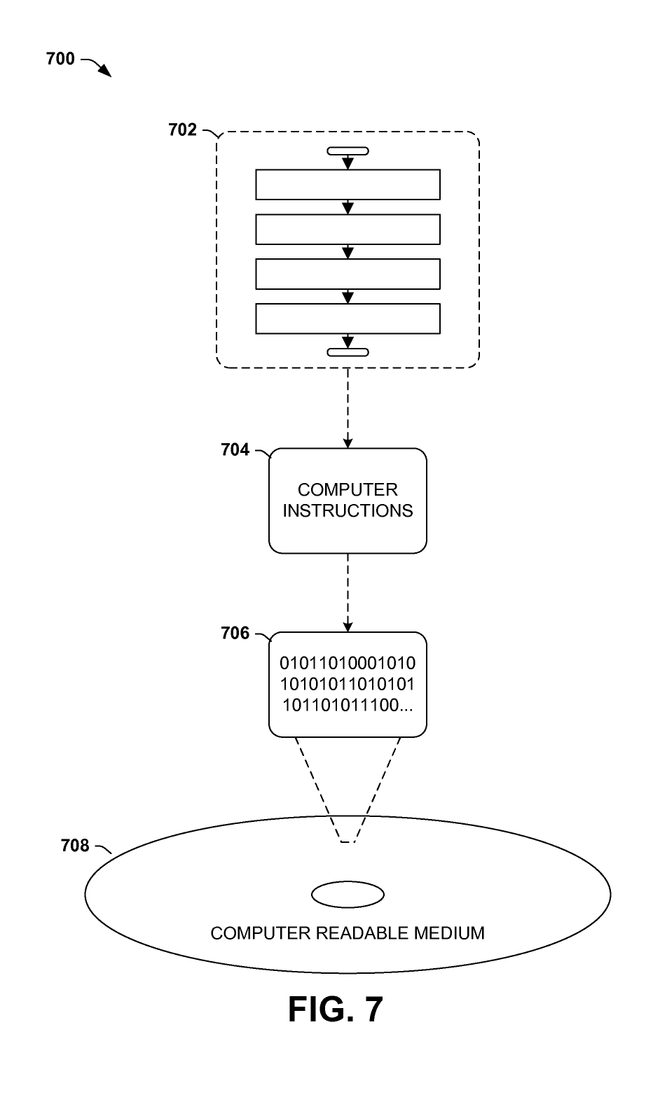

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 200 of FIG. 2, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

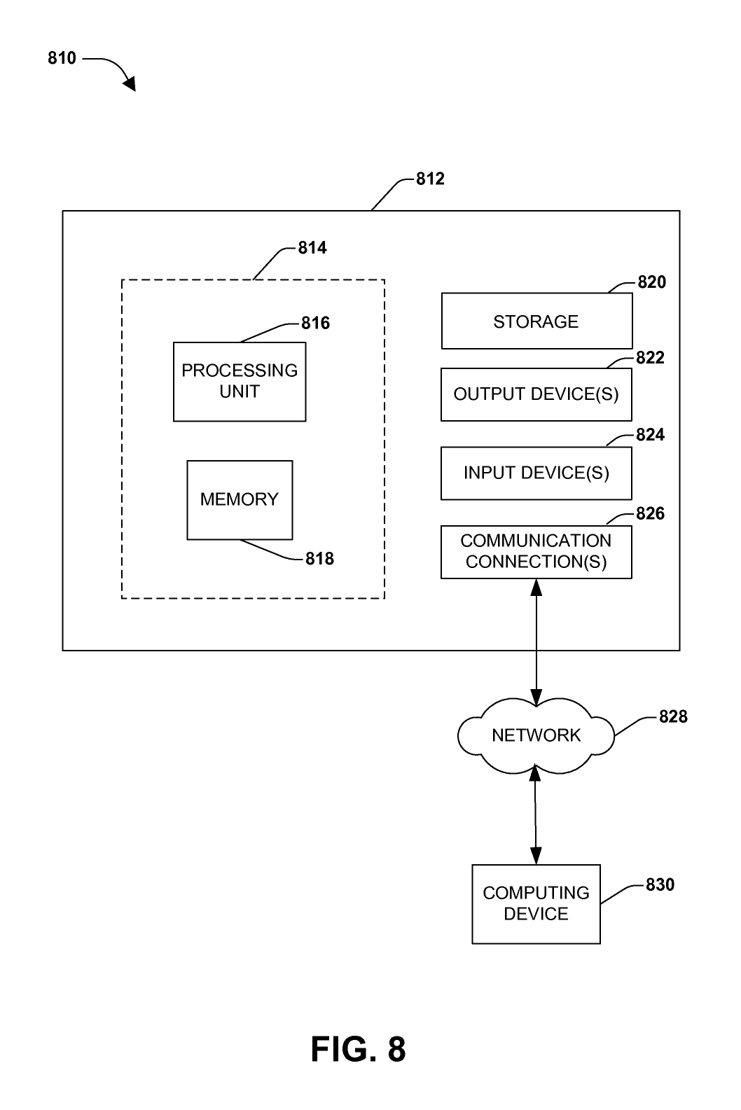

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for virtualizing data in a user interface (UI), comprising:
identifying a virtual layout viewport comprising a viewable UI area where at least some data from one or more tuples of data is realized;
identifying data from the one or more tuples of data to be realized in the viewport, using a computer-based processor;
realizing the identified data in the viewport; and
virtualizing realized data when the virtual layout viewport is modified in relation to a display of tuple data.

2. The method of claim 1, realizing data comprising creating a UI representation of the identified data for display in the viewport.

3. The method of claim 1, virtualizing data comprising eliminating a UI representation of at least some of the realized data from display in the viewport.

4. The method of claim 1, identifying a virtual layout viewport comprising identifying the viewable UI area based on a user interaction with the UI.

5. The method of claim 1, identifying data comprising identifying data from the one or more tuples that is viewable in the UI area in relation to the one or more tuples.

6. The method of claim 1, modifying the viewport comprising a user virtually moving a location of the viewport over tuple data.

7. The method of claim 1, comprising identifying one or more layouts for the realized data.

8. The method of claim 7, comprising realizing respective portions of the realized data in the respective one or more layouts in the virtual layout viewport.

9. The method of claim 1, comprising nesting at least one second virtual layout viewport in the virtual layout viewport.

10. The method of claim 9, comprising nesting at least one third virtual layout viewport in the second virtual layout viewport.

11. The method of claim 9, comprising providing for selection of realized data in one or more nested virtual layout viewports using an n-tuple index.

12. The method of claim 9, comprising providing for selection of realized data in one or more nested virtual layout viewports by selecting a range of elements in an n-tuple index.

13. A system for virtualizing data in a user interface (UI), comprising:
a processor for processing data for the system;
a virtual layout component operably coupled with the processor, and configured to:
identify a virtual viewing area of the UI in which realized data from one or more tuples of data relationally coupled with the UI is displayed; and
realize and virtualize data from the one or more tuples in the virtual viewing area; and
a layout mode component operably coupled with the virtual layout component and configured to identify a layout of realized data based on the identified virtual viewing area.

14. The system of claim 13, the virtual layout component comprising a layout engine configured to identify the data from the one or more tuples to be realized using the virtual viewing area and the layout of the realized data.

15. The system of claim 14, the virtual layout component comprising a layout manager configured to:
realize and virtualize the data; and
maintain a list of data identified by the layout engine.

16. The method of claim 14, the virtual layout component comprising a viewport component configured to:
maintain the virtual viewing area that is exposed to a user of the UI;
display the realized data in the virtual viewing area; and
provide for the user to modify a location of the virtual viewing area in relation to tuple data.

17. The system of claim 13, comprising a nesting component configured to nest a second UI control comprising a second virtual viewing area in a first UI control comprising a first virtual viewing area.

18. The system of claim 17, comprising a selection component configured to select realized data in one or more nested UI controls using an n-tuple index to identify the realized data selected.

19. The system of claim 13, the layout mode component coupled with an application utilizing the UI to display the realized data and configured to layout the realized data in a desired data layout for display in the virtual viewing area.

20. A computer-based method for virtualizing data in a user interface (UI), comprising:
identifying a virtual layout viewport comprising a viewable UI area where at least some data from one or more tuples of data is realized, the identifying comprising identifying the viewable UI area based on a user interaction with the UI;
identifying data from the one or more tuples of data to be realized in the viewport using a computer-based processor, comprising identifying data from the one or more tuples that is viewable in the UI area at a location of the UI area in relation to the one or more tuples;
realizing the identified data in the viewport comprising creating a UI representation of the identified data for display in the viewport;
virtualizing realized data when the virtual layout viewport is modified in relation to a display of tuple data, comprising eliminating the UI representation of at least some of the realized data from display in the viewport;
nesting at least one second virtual layout viewport in the virtual layout viewport; and
providing for selection of realized data in one or more nested virtual layout viewports using an n-tuple index.
